(19) United States
(12) Patent Application Publication
(10) Pub. No.: US 2006/0051620 A1
(43) Pub. Date: Mar. 9, 2006

(54) Magnetic recording medium with high areal recording density and magnetic recording apparatus

(75) Inventors: Tatsuya Hinoue, Kanagawa (JP); Jo Inagaki, Kanagawa (JP); Hiroyuki Suzuki, Kanagawa (JP); Kohei Tozawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/223,407

(22) Filed: Sep. 9, 2005

(30) Foreign Application Priority Data
Sep. 9, 2004 (JP) 2004-262853

(51) Int. Cl. G11B 5/66; G11B 5/23

(52) U.S. Cl. 428/828.1; 428/829; 428/831; 360/119

(57) ABSTRACT

A magnetic recording medium for attaining high areal recording density and a magnetic recording apparatus are provided. In one embodiment, a magnetic recording medium is provided which includes underlayers, a first magnetic layer, a first intermediate layer, a second magnetic layer, a second intermediate layer, a third magnetic layer, a protective layer and a lubricant layer formed in sequence on a substrate. The first magnetic layer comprises a cobalt-based alloy, and the second magnetic layer and the third magnetic layer each comprises a Co-based alloy containing platinum, chromium and boron. The concentration of chromium contained in the third magnetic layer is less than that in the second magnetic layer, the concentration of chromium contained in the third magnetic layer is about 15 at. % or less, and the first intermediate layer comprises ruthenium or an alloy having ruthenium as a main ingredient.

### CROSS-REFERENCES TO RELATED APPLICATIONS

This application claims priority from Japanese Patent Application No. JP2004-262853, filed Sep. 9, 2004, the entire disclosure of which is incorporated herein by reference.

### BACKGROUND OF THE INVENTION

The present invention relates to a magnetic recording apparatus capable of recording large capacity information and, particularly, it relates to a magnetic recording medium suitable for high density magnetic recording and a manufacturing method thereof.

For magnetic storage apparatus typically represented by a magnetic disk drive, a demand for larger capacity has increased more and more. To satisfy the demand, development for magnetic heads with high sensitivity and magnetic recording media capable of obtaining a high signal amplitude to noise ratio (S/Nd) has been demanded.

Generally, a recording medium comprises a first underlayer referred to as a seed layer, a second underlayer whose structure is body centered cubic comprising a chromium alloy, a magnetic layer, a protective layer mainly comprising carbon and a lubricant layer mainly comprising perfluoro alkyl polyether, which are formed on a substrate. For the magnetic layer, a cobalt-based alloy whose structure is hexagonal close-packed is used.

To improve S/Nd, it is effective that c-axis of the magnetic layer having hexagonal close-packed structure, which is an easy axis of the magnetization, is directed to in-plane direction by making (11.0) plane or (10.0) plane of the magnetic layer parallel to the surface of the substrate. It has been known that the crystal orientation of the magnetic layer can be controlled by a seed layer and such orientation can be obtained by using, for example, tantalum or an NiAl alloy having B2 structure as the seed layer. Further, it has been known that the magnetic property in the circumferential direction can be improved also by introducing magnetic anisotropy in the circumferential direction by applying mechanical texturing to the surface of the substrate.

To improve S/Nd, it is effective to take a multi-layered structure for the magnetic layer, refine the crystal grain size, and decrease Br·t which is a product of the residual magnetic flux density (Br) and the film thickness of the magnetic layer. That is, a magnetic recording medium has been proposed which is formed on a substrate by depositing underlayers, and magnetic layers which have at least two layers separated by way of non-magnetic layers such as ruthenium. In addition, a magnetic recording medium has been proposed which is formed on a substrate by depositing underlayers and magnetic layers in this order, and the magnetic recording layers are separated vertically by intermediate layers, the interlayers comprise one of materials selected from Ru, Rh, Ir and alloys thereof, the thickness of the intermediate layers is from 0.2 to 0.4 nm or from 1.0 to 1.7 nm, and the magnetization of the magnetic recording layers separated by the intermediate layers is in parallel with each other. Such magnetic recording media described above realize low noise and enough thermal stability to maintain the magnetic property.

Reduction of noise is limited since the thermal stability is deteriorated when the grain size of the magnetic recording layer is refined extremely, or Br·t is greatly decreased. In recent years, an anti-ferromagnetically coupled (AFC) medium has been proposed as a technique compatibilizing the thermal stability and low noise. AFC medium has two magnetic layers which are anti-ferromagnetically coupled by way of Ru intermediate layer. This structure can make Br·t lower while the magnetic film is kept thicker compared with the medium comprising a single magnetic layer. Accordingly, reduction of the medium noise has become possible while the thermal stability is maintained.

Patent Document 1 (US Patent Publication No. 2002/98390A1) discloses a longitudinal magnetic recording medium stacked on a substrate in which a magnetic recording layer comprises an AFC layer and a single ferromagnetic layer spaced apart by a non-ferromagnetic spacer layer. The AFC layer is formed as two ferromagnetic films antiferromagnetically coupled together across an antiferromagnetically coupling film that has a composition and thickness to induce antiferromagnetic coupling. In each of the two remanent magnetic states, the magnetic moment of the two antiferromagnetically coupled films in the AFC layer are oriented antiparallel, and the magnetic moment of the single ferromagnetic layer and the greater-moment ferromagnetic film of the AFC layer are oriented parallel. The non-ferromagnetic spacer layer has a composition and thickness to prevent antiferromagnetic exchange coupling. Further, it discloses a medium in which Co-12 at. % Pt-14 at. % Cr-11 at. % B alloy is used as the greater-moment magnetic film of the AFC layer and the single ferromagnetic layer in column No. 51.

### BRIEF SUMMARY OF THE INVENTION

Even when the techniques described above are combined, however, this is still insufficient to attain an areal recording density of 150 Mbit per mm² or more and it is necessary to further improve the signal amplitude and improve S/Nd.

A feature of the present invention is to provide a longitudinal magnetic recording medium having high S/Nd, enough overwrite-characteristics and sufficient stability against thermal fluctuation.

An exemplary embodiment of the invention disclosed in the present patent application will be described as below. A magnetic recording medium is provided in which an underlayer, a first magnetic layer, a first intermediate layer, a second magnetic layer, a second intermediate layer, a third magnetic layer, a protective layer, and a lubricant layer are formed successively on a substrate. The second magnetic layer and the third magnetic layer each comprise a cobalt (Co)-based alloy containing platinum (Pt), chromium (Cr), and boron (B). The concentration of chromium contained in the third magnetic layer is less than that in the second magnetic layer. The concentration of chromium contained in the third magnetic layer is about 15 at. % or less.

Further, a magnetic disk apparatus is provided which includes a combination of a medium having the constitution described above and a magnetic head in which the ratio of a writing gap length and a geometrical writing track width is from about 1.5 to 2.1.

The invention can provide a longitudinal magnetic recording medium having a high S/Nd, enough overwrite-characteristics and sufficient stability against thermal fluctuation. Further, it can provide a magnetic recording apparatus whose areal recording density is 150 Mbit/mm² or more.

### BRIEF DESCRIPTION OF THE DRAWINGS

FIG. 1 is a schematic view illustrating the film constitution of a magnetic recording medium to which the invention is applied.

FIG. 2 is a graph showing the dependence of S/Nd on the total content of Co and Pt.

FIG. 3 is a graph showing the dependence of O/W on the total content of Co and Pt.

FIG. 4 shows the structure examples of heads used for evaluation of characteristics.

FIG. 5 shows the dependence of R/W performance on the Cr concentration of a third magnetic layer.

FIG. 6 shows the dependence of R/W performance on the Cr concentration of a third magnetic layer.

FIG. 7 shows the dependence of R/W performance on the Cr concentration in the second and the third magnetic layer.

FIG. 8 shows the dependence of R/W performance on the concentration of Cr and B in the third magnetic layer.

FIG. 9 shows the dependence of R/W performance on the concentration of Cr and B in the third magnetic layer.

FIG. 10 shows the dependence of R/W performance on the concentration of Cr and B in the third magnetic layer.

FIG. 11 shows the dependence of R/W performance on the concentration of Cr and B in the third magnetic layer.

FIG. 12 shows the dependence of R/W performance on the Ta concentration in the third magnetic layer.

FIG. 13 shows dependence of R/W performance on the Cu concentration in the third magnetic layer.

FIG. 14 shows the dependence of R/W performance on the concentration of Ta and Cu in the third magnetic layer.

FIG. 15 shows the R/W performance on the Pt concentration in the third magnetic layer.

FIG. 16 shows the dependence of R/W performance on the film thickness of the second intermediate layer.

FIG. 17 shows the dependence of R/W performance on the material and film thickness of the second intermediate layer.

FIG. 18 shows a magnetic disk apparatus using a magnetic recording medium according to the invention and a magnetic head.

FIG. 19 is a schematic perspective view showing the structure of the magnetic head.

### DETAILED DESCRIPTION OF THE INVENTION

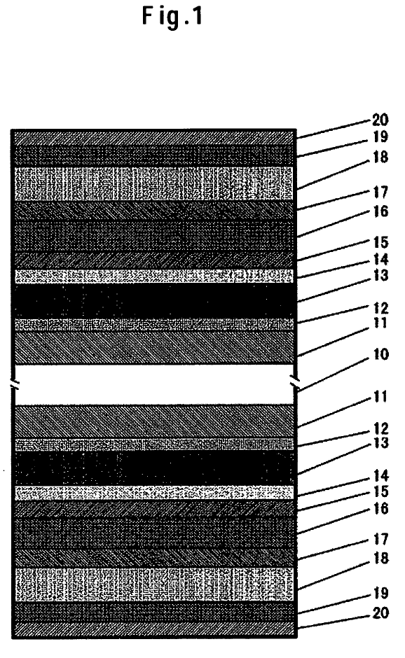

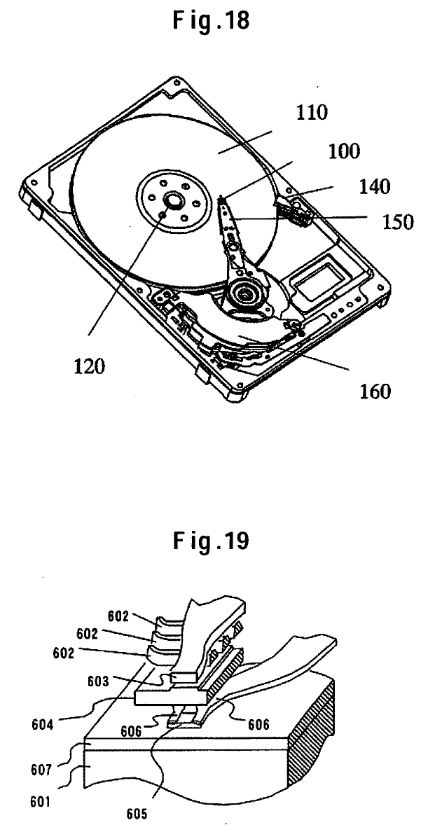

FIG. 18 shows an example of a magnetic disk drive to which a magnetic recording medium and a magnetic head described in embodiments shown later are applied. The magnetic disk drive includes a magnetic storage medium (disk) 110, a disk fixing mechanism 120, a ramp mechanism 140, voice coil motor (VCM) 160, a head stack assembly (HSA) 150, and a magnetic head 100. FIG. 19 is a schematic perspective view showing the structure of a magnetic head. The magnetic head 100 is a compound head having an electromagnetic inductive writing head and a magnetoresistive reading head together. The writing head has an upper writing pole piece 603 and a lower writing pole-upper shield layer 604 that sandwich coils 602 therebetween. In this text, a writing width is referred to as Tww and a writing gap length is referred to as Gl. The read head includes a magnetoresistive sensor 605 and electrode patterns 606 on both ends thereof, and the magnetoresistive sensor is put between the lower writing pole-upper shield layer 604 and a lower shield layer 607 which is disposed on a substrate 601. In this text, a reading track width is referred to as Twr and the gap length between the two shield layers is referred to as Gs. In the drawings, the gap layer between the writing pole pieces and the gap layer between the shield layer and the magnetoresistive sensor are not shown. The storage medium 110 of the invention has a film constitution as shown in FIG. 1 in which underlayers 11, 12, 13, a first magnetic layer 14, a first intermediate layer 15, a second magnetic layer 16, a second intermediate layer 17, a third magnetic layer 18, a protective layer 19, and a lubricant layer 20 are deposited in sequence on both surfaces of the substrate 10. Examples of the invention are to be described specifically with reference to the drawings.

### EXAMPLE 1

As the substrate, a glass substrate, an aluminum-magnesium (Al—Mg) alloy substrate coated with a nickel-phosphorus (Ni—P) plating film, or a ceramic substrate is used. It is preferred to use a substrate applied at the surface thereof with texturing and form a magnetic layer and a protective layer by way of an underlayer on the substrate. When a substrate in which concentrical grooves are formed on the surface by texturing is used, since Br·t measured in the circumferential direction is larger than Br·t measured in the radial direction, the thickness of the magnetic layer can be reduced to enhance the signal amplitude resolution. While the texturing may be applied after formation of the underlayer, it is preferred to apply texturing directly to the surface of the substrate, and then form thin films continuously after cleaning and drying.

The underlayers (11, 12, 13) have a first underlayer (11) comprising a titanium (Ti) alloy containing at least one element selected from cobalt (Co) and nickel (Ni), a second underlayer (12) comprising a tungsten (W) alloy containing cobalt (Co), and a third underlayer (13) comprising a chromium (Cr) alloy containing titanium (Ti) and boron (B) formed in this order. The titanium alloy layer containing at least one element selected from cobalt and nickel, the tungsten alloy layer containing cobalt, and the Cr alloy layer containing Ti and B are preferably used as the underlayer to be formed on the substrate. This is because the magnetic layer formed on the underlayer can be easily given in-plane orientation magnetically and the crystal grain size of the magnetic layer can be refined to reduce the medium noise. Further, when the surface of the tungsten alloy layer containing cobalt is oxidized intentionally in an oxygen atmosphere or in a mixed gas atmosphere of Ar with addition of oxygen after formation of the tungsten alloy layer containing cobalt, (100) orientation of the Cr alloy underlayer can be improved further. Since use of alloy layer having an amorphous structure instead of the titanium alloy layers containing at least one element selected from cobalt and nickel and the tungsten alloy layer containing cobalt can provide a similar or identical effect, there is no particular restriction. The amorphous structure of the alloy layers was identified based on the fact that it showed no distinct diffraction peak other than the hallo pattern in an X-ray diffraction curve using Cu Kα₁ X-ray, or based on the fact that the average grain size obtained from lattice images photographed by a high resolution electron microscope was 5 nm or less. When an alloy layer having a body centered cubic structure comprising Cr as a main ingredient is formed on the amorphous alloy layers, the Cr alloy layer can be oriented in (100) plane.

The magnetic layer formed on the Cr alloy layer containing Ti and B is preferred since the crystal grains are refined to reduce the medium noise. Instead of the Cr alloy, it is also possible to use a Cr alloy containing at least one element selected from Ti, molybdenum (Mo), and W, or an alloy having a body centered cubic structure comprising Cr as a main ingredient. Alternatively, a multi-layered structure comprising the alloy layers such as (Cr—Mo)/(Cr—Ti) may also be used.

The first magnetic layer (14) is a Co-based alloy. The film thickness is preferably reduced to such an extent as capable of anti-ferromagnetically coupling, although it depends on the composition of the magnetic film. It is preferred that the first magnetic layer is a Co-based alloy containing Cr or a Co-based alloy containing Cr and Pt to give easily in-plane orientation magnetically on the underlayer.

The first intermediate layer (15) for attaining the anti-ferromagnetical exchange coupling between the first and second magnetic layers (14, 16) comprises ruthenium (Ru) as a main ingredient. When a layer comprising Ru as the main ingredient at a thickness of 1.5 nm or less is formed by using a sputtering target containing Ru, the layer sometimes contains the constituent elements in the upper and lower layers. For the first intermediate layer, an alloy comprising at least one element selected from Ru, iridium (Ir) and rhodium (Rh) or the elements described above as the main ingredient can be used, for instance. The thickness is preferably from 0.5 to 0.8 nm since the first magnetic layer and the second magnetic layer tend to be anti-ferromagnetically coupled with each other to give less thermal fluctuation. The first magnetic layer and the first intermediate layer are preferred to give small Br t with enough coercivity even when the thickness of the second magnetic layer is thicker compared with the case of not forming the first magnetic layer and the first intermediate layer.

Each of the second magnetic layer (16) and the third magnetic layer (18) is a Co-based alloy containing Pt, Cr and B. This is because Pt is essential to increase the coercivity, and Cr and B are essential to reduce the medium noise. Further, the concentration of chromium contained in the third magnetic layer is less than that in the second magnetic layer, and the concentration of chromium contained in the third magnetic layer is 15 at. % or less.

The second intermediate layer (17) disposed between the second and third magnetic layers (16, 18) to attain anti-ferromagnetical coupling between both the layers contains Ru. The protective layer (19) comprises carbon as a main ingredient and the lubricant layer (20) comprises a perfluoro alkyl polyether as a main ingredient.

At first, to achieve a high areal recording density, a structure of a head optimal to this medium has been studied. The medium used as specimens was manufactured as described below. An alumino silicate glass substrate 10 chemically strengthened at the surface was put to alkali cleaning and drying, then an argon (Ar) gas was introduced in a vacuum, and a 15 nm-thick Ti-40 at. % Co-10 at. % Ni alloy layer as a first underlayer 11 and a 3 nm-thick W-30 at. % Co alloy layer as a second underlayer 12 were formed on the substrate by a sputtering method at room temperature. Then, after heating the substrate by using a lamp heater, a 10 nm-thick Cr-10 at. % Ti-3 at. % B alloy layer as a third underlayer 13 was formed. Further, a 3 nm-thick first magnetic layer 14 comprising a Co-16 at. % Cr-9 at. % Pt alloy layer, a 0.6 nm-thick first intermediate layer 15 comprising Ru, a second magnetic layer 16 comprising a Co-16 at. % Cr-12 at. % Pt-8 at. % B alloy, a 0.8 nm-thick second intermediate layer comprising Ru, and a third magnetic layer 18 comprising a Co-14 at. % Cr-14 at. % Pt-8 at. % B alloy were formed in sequence, and a 3 nm-thick carbon film 19 was formed as a protective layer.

After formation of the carbon film, a 1.8 nm-thick lubricant layer 20 comprising perfluoro alkyl polyether as a main ingredient was coated. The multi-layered film described above was formed by using a single-wafer sputtering apparatus (MDP250B) manufactured by Intevac Corp. The base vacuum pressure of the sputtering apparatus was 1.0 to 1.2×10⁻⁵ Pa, and the tact time was set to 7 sec. From the first underlayer to the third magnetic layer were formed in Ar gas atmosphere at 0.93 Pa, and the carbon protective film was formed in a mixed gas atmosphere comprising Ar with addition of 10% nitrogen. The substrate was heated in a mixed gas atmosphere comprising Ar with addition of 1% oxygen, and the heating temperature was controlled such that the coercivity of the manufactured magnetic recording medium was within a range from 300 to 320 kA/m.

The magnetic properties and the R/W performance of the manufactured magnetic recording medium were evaluated by the following method. The magnetic properties were evaluated by using vibrating sample magnetometer (VSM) while applying 796 kA/m at the maximum in the circumferential direction at room temperature. The R/W performance was evaluated by a spin stand having a combination of an electromagnetic inductive writing head and a spin valve type reading magnetic head. The writing gap length (GI) was 100 nm, the inter-shield gap length (Gs) was 56 nm, and the geometrical reading track width (Twr) was 100 nm, and the geometrical writing track width (Tww) was 180 nm for the head used for the evaluation of the R/W performance. After writing at a signal at 5.31 kFC/mm (135 kFCI) as an 1F signal for low recording density, a signal at 31.9 kFC/mm (810 kFCI) as a 2F signal for high recording density were overwritten to determine an overwrite characteristic (O/W) based on the decay ratio of the 1F signal. S/Nd was defined as: S/Nd=20 log (So/Nd2F) by using the medium noise (Nd2F) at the high recording density which is 34.9 kFC/mm and the isolated pulse signal amplitude (So).

Assuming the film thickness and the residual magnetic flux density of the first magnetic layer as t1 and Br1, respectively, the film thickness and the residual magnetic flux density of the second magnetic layer as t2 and Br2, respectively, and the film thickness and the residual magnetic flux density of the third magnetic layer as t3 and Br3, respectively, Br·t in this example is about: Br t=Br3—t3+Br2−t2−Br1·t1. When the thickness of each of the second and the third magnetic layers was changed such that Br·t was substantially equal by using the magnetic alloy target described above, the absolute value of O/W was maximized and the signal decay due to thermal fluctuation was improved under the condition where the thickness of each of the layers was: about Br3·t3=Br2−t2−Br1−t1.

The magnetic recording medium whose Br·t was in a range from 4T·nm to 10T·nm by controlling the thicknesses of the second and third magnetic layers was formed such that substantially Br3·t3=Br2−t2−Br1·t1 by using the magnetic alloy target described above. In this case, the absolute value of O/W was decreased monotonously along with increase of Br·t. This tendency of O/W did not depend on the film composition of the magnetic layers. Br·t and O/W had a relation as: O/W=−35 dB at Br·t=6T·nm and O/W=−27 dB at Br·t=10T·nm. The signal decay due to thermal fluctuation was improved along with increase of Br·t. In the medium described in this example, the signal decay was about from −1.4%/decade to 1.5%/decade so long as Br·t was 7.5 T·nm or more, which was sufficiently stable against thermal fluctuation and had no problem from the view point of the reliability. The thermal decay at 65° C. was evaluated by the decay rate of the signal amplitude when the medium was left for 1 sec to 1000 sec after recording. The R/W performance was evaluated by using heads with changing the writing gap length (Gl), the inter-shield gap length (Gs), geometrical reading track width (Twr), and the geometrical writing track width (Tww) at a low recording density as IF signal which is 5.31 kFC/mm (135 kFCI) and at a high density recording as 2F signal which is 31.9 kFC/mm (810 kFCI). While O/W was somewhat deteriorated in the head with increased writing gap length (Gl) (specimen No. (SAMPLE #)003), it was within an allowable range. S/Nd was somewhat deteriorated in the head with increased inter-shield gap length (Gs) (specimen No. (SAMPLE #)005), but it was within an allowable range. S/Nd was somewhat deteriorated in the head with increased geometrical reading track width (Twr)(specimen No. (SAMPLE #)006), but it was within an allowable range. O/W was somewhat deteriorated in the head with increased geometrical reading track width (Twr)(specimen No. (SAMPLE #)008), but it was within an allowable range.

Films were formed directly on a glass substrate by using the three kinds of targets described above, and the compositions of the films were analyzed by inductively coupled plasma spectroscopy (ICPS). As a result, the compositions of the targets are almost the same as the compositions of the films.

The specimen in which only the first underlayer was formed and the second and subsequent layers were not formed showed no distinct diffraction peak other than the hallo pattern on the X-ray diffraction curve using Cu Kα1 X-ray. An X-ray diffraction curve for a specimen in which the layers were formed as far as the protective film showed no distinct diffraction peak except for 200 diffraction peak attributable to the third underlayer having a body centered cubic structure, and 11.0 diffraction peak attributable to the first magnetic layer, the second magnetic layer and the third magnetic layer having the hexagonal close-packed structure.

### COMPARATIVE EXAMPLE 1

A magnetic recording medium was formed in the same manner as the magnetic recording media described in Example 1 except for using a Co-16 at. % Cr-14 at. % Pt-8 at. % B alloy for the third magnetic layer.

That is, after an alumina silicate glass substrate 10 chemically strengthened at the surface was alkali cleaned and dried, an argon gas was introduced in a vacuum, and a 15 nm-thick Ti-40 at. % Co-10 at. % Ni alloy layer as the first underlayer 11 and a 3 nm-thick W-30 at. % Co alloy layer as the second underlayer 12 were formed on the substrate by a sputtering method at room temperature. Then, the substrate was heated by a lamp heater and a 10 nm-thick Cr-10 at. % Ti-3 at. % B alloy layer as the third underlayer 13, a 3 nm-thick first magnetic layer 14 comprising a Co-16 at. % Cr-9 at. % Pt alloy, a 0.6 nm-thick first intermediate layer 15 comprising Ru, a second magnetic layer 16 comprising a Co-16 at. % Cr-12 at. % Pt-8 at. % B alloy, a 0.8 nm-thick second intermediate layer 17 comprising Ru, and a third magnetic layer 18 comprising a Co-16 at. % Cr-14 at. % Pt-8 at. % B alloy were formed in sequence, and a 3.0 nm-thick carbon film 19 was formed as a protective layer.

The thicknesses of the second and third magnetic layers were controlled such that Br3·t3=Br2−t2−Br1·t1 at about Br·t=8 T·nm. FIG. 5 shows the result for the evaluation of S/Nd and O/W of the media by using a head whose writing gap length was 100 nm, inter-shield gap length was 56 nm, geometrical reading track width was 100 nm and geometrical writing track width was 180 nm at a low recording density IF signal of 5.31 kFC/mm (135 kFCI) and a high recording density 2F signal of 31.9 kFC/mm (810 kFCI) and, shows the result for evaluation of Ku·v/kT. FIG. 5 also shows the result for evaluation of the medium in Example 1 at about Br·t=8 T·nm.

In this case, Ku·v/kT (Ku: crystal magnetic anisotropy constant, v: volume of a magnetic crystal grain, k: Boltzmann's constant, T: absolute temperature) was determined by fitting the time dependence of the remanence coercivity from 7.5 to 240 sec at room temperature to Sharrock's formula. From the studies made by the present inventors, the signal decay caused by thermal fluctuation could be suppressed enough to result in no problem in view of the reliability when Ku·v/kT determined by the method described above was about 71 or more. All the media in this example had Ku·v/kT of 71 or more, with no problem of reliability against thermal fluctuation.

In view of FIG. 5, the medium using Co-14 at. % Cr-14 at. % Pt-8 at. % B as the third magnetic layer (specimen No. (SAMPLE #)101) could obtain excellent S/Nd which was 24.5 dB and the good absolute value of O/W which was 32 dB. On the other hand, in the medium using Co-16 at. % Cr-14 at. % Pt-8 at. % B as the third magnetic layer (specimen No. (SAMPLE #)102), S/Nd was deteriorated by 1.2 dB to 23.3 dB, while the absolute value of O/W was deteriorated by 4 dB to 28 dB.

FIG. 6 shows the result for evaluation of the media of specimen Nos. (SAMPLE #) 101 and 102 by using a head whose writing gap length was 110 nm, inter-shield gap length was 65 nm, geometrical track width was 130 nm, and geometrical writing track width was 240 nm at a low recording density 1F signal which was 5.31 kFC/mm (135 kFCI) and at a high recording density 2F signal which was 31.9 kFC/mm (810 kFCI).

In view of FIG. 6, the medium using Co-16 at. % Cr-14 at. % Pt-8 at. % B as the third magnetic layer (specimen No. (SAMPLE #)102) could obtain excellent S/Nd which was 24.0 dB and the good absolute value of O/W which was 31 dB. On the other hand, for the medium using Co-14 at. % Cr-14 at. % Pt-8 at. % B as the third magnetic layer (specimen No. (SAMPLE #)101), S/Nd was deteriorated by 0.9 dB.

That is, in a case where the geometrical writing track width, etc. of the head were relatively small, better S/Nd was obtained when the Cr concentration of the third magnetic layer was 14 at. % and, on the other hand, in a case where the geometrical writing track width of the head, etc. were relatively large, better S/Nd was obtained when the Cr concentration of the third magnetic layer was 16 at. %.

The phenomena described above can be explained as below. Since magnetization of the third magnetic layer increases by decreasing the Cr concentration in the third magnetic layer from 16 at. % to 14 at. %, the thickness of the third magnetic layer can be reduced when the medium is formed so that Br·t is generally equal. Accordingly, in a case of using a head with a small geometrical writing track width having a relatively low writing performance, good O/W and good S/Nd could be obtained on a medium using the Co-14 at. % Cr-14 at. % Pt-8 at. % B for the third magnetic layer of a smaller thickness (specimen No. (SAMPLE #)101). On the other hand, for a medium using Co-16. at. % Cr-14 at. % Pt-8 at. % B for the third magnetic layer which has a larger thickness, since enough O/W could not be obtained and a substantial writing width was decreased, S/Nd was deteriorated because of reading the track edge noise.

On the contrary, in a case of using a head with a large writing track width having relatively high writing performance, sufficient O/W can be obtained even on the medium using Co-16. at. % Cr-14 at. % Pt-8 at. % B for the third magnetic layer which has larger thickness (sample No. (SAMPLE #)102). In this case, the medium noise was decreased more and higher S/Nd could be obtained because higher concentration of Cr is effective to reduction of the medium noise.

Accordingly, an intended recording density can be obtained by the combination of the medium described above and a magnetic head having the ratio (Tww/Gl) of the writing gap length to the geometrical writing track width being about 1.5 to 2.1. Specifically, a particularly excellent recording density can be attained by combining the medium to be described below and a magnetic head constituting the magnetic recording apparatus having a magnetic head whose writing gap length was about 115 nm or less, inter-shield gap length was about 64 nm or less, geometrical reading track width was about 122 nm or less and geometrical writing track width was about 206 nm or less.

Then, to demonstrate the effect of the Cr concentration in the second magnetic layer (16) and the third magnetic layer (18) on the R/W performance, media whose content of the second and third magnetic layers was changed were formed in the same manner described above. As the materials for use in the second magnetic layer 16 comprising Co as the main ingredient, the following three kinds of alloy targets were used:
Co-14. at. % Cr-12 at. % Pt-6 at. % B,
Co-16. at. % Cr-12 at. % Pt-6 at. % B,
Co-18. at. % Cr-12 at. % Pt-6 at. % B, and
as the material of the third magnetic layer 18, the following three kinds of alloy targets were used:
Co-14. at. % Cr-14 at. % Pt-8 at. % B,
Co-15. at. % Cr-14 at. % Pt-8 at. % B,
Co-16. at. % Cr-14 at. % Pt-8 at. % B.

Magnetic recording media were formed by controlling the film thickness of the second and the third magnetic layers so that Br3·t3=Br2·t2−Br1·t1 at about Br·t=8 T·nm.

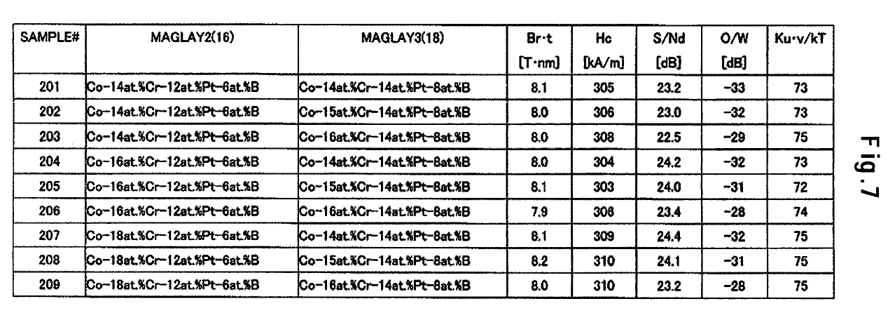

FIG. 7 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), shows and the results of the evaluation of Ku·v/kT.

In view of FIG. 7, all the media in this example have Ku·v/kT of 71 or more and show no problem with the reliability against thermal fluctuation. Good S/Nd which was 24 dB or more and the good absolute value of O/W which was 30 dB or more were obtained on media whose Cr concentration in the third magnetic layer was about 15 at. % or less and was less than the Cr concentration in the second magnetic layer, such that the specimen No. (SAMPLE #) were 204, 205, 207 and 208. On the contrary, while the absolute value of O/W was 30 dB or more, S/Nd was deteriorated by 0.5 dB or more to 23.5 dB or less for all the media whose Cr concentration in the third magnetic layer was higher than the Cr concentration in the second magnetic layer, such that the specimen Nos. (SAMPLE #) 201 and 202. Further, the absolute value of O/W was decreased to 29 dB or less and also S/Nd was less than 23.5 dB or less for all the media whose Cr concentration in the third magnetic layer was 16 at. %, such that the specimen Nos. (SAMPLE #) were 203, 206 and 209.

It is preferred that the concentration of chromium contained in the third magnetic layer is less than that in the second magnetic layer and that the concentration of chromium contained in the third magnetic layer is about 15 at. % or less. This is because reduction of the medium noise, i.e., higher S/Nd and overwrite characteristics are compatible. Elements such as Cr and B are added for refining the crystal grain size of the magnetic film to attain high S/Nd while keeping the thermal stability, and S/Nd can be improved while keeping good overwrite characteristic when the concentration of chromium contained in the third magnetic layer is less than that in the second magnetic layer. When the concentration of Cr contained in the third magnetic layer is higher than about 15 at. %, the magnetic layer becomes excessively thick in order to keep the thermal stability. As a result, the overwrite characteristic is deteriorated and the medium noise increase. Further, when the concentration of Cr contained in the third magnetic layer is higher than that in the second magnetic layer, the exchange interaction between crystal grains in the second magnetic layer becomes stronger than the exchange interaction between the crystal grains in the third magnetic layer. As the exchange interaction between the crystal grains becomes stronger, higher writing field is required for magnetization reversal. Therefore, when the writing field in the second magnetic layer whose exchange interaction between the crystal grains was relatively small, noise due to the second magnetic layer increases and also noise of the entire medium increases.

As has been described above, when the concentration of Cr in the third magnetic layer is about 15 at. % or less and the concentration of Cr in the third magnetic layer is less than that in the second magnetic layer, a magnetic recording medium having an adequate S/Nd to attain an areal recording density of 150 or more Mbit per mm², and enough O/W characteristic and sufficient stability against thermal fluctuation can be obtained.

### EXAMPLE 2

The concentration of cobalt (Co) and platinum (Pt) contained in the third magnetic layer (18) was studied in view of S/Nd, overwrite characteristic and thermal stability. In the study, the following alloy targets whose Pt content was fixed and ratio of Co, Cr, and B was changed were used for the third magnetic layer 18 comprising Co as the main ingredient, and magnetic recording media were formed by using the same manufacturing method as described in Example 1.
Co-6 at. % Cr-13 at. % Pt-8 at. % B,
Co-6 at. % Cr-13 at. % Pt-12 at. % B,
Co-6 at. % Cr-13 at. % Pt-16 at. % B,
Co-8 at. % Cr-13 at. % Pt-8 at. % B,
Co-8 at. % Cr-13 at. % Pt-12 at. % B,
Co-8 at. % Cr-13 at. % Pt-16 at. % B,
Co-10 at. % Cr-13 at. % Pt-8 at. % B,
Co-10 at. % Cr-13 at. % Pt-12 at. % B,
Co-10 at. % Cr-13 at. % Pt-16 at. % B,
Co-12 at. % Cr-13 at. % Pt-8 at. % B,
Co-12 at. % Cr-13 at. % Pt-12 at. % B,
Co-12 at. % Cr-13 at. % Pt-16 at. % B,
Co-14 at. % Cr-13 at. % Pt-8 at. % B,
Co-14 at. % Cr-13 at. % Pt-12 at. % B,
Co-14 at. % Cr-13 at. % Pt-16 at. % B,
Co-16 at. % Cr-13 at. % Pt-8 at. % B,
Co-16 at. % Cr-13 at. % Pt-12 at. % B,
Co-16 at. % Cr-13 at. % Pt-16 at. % B.

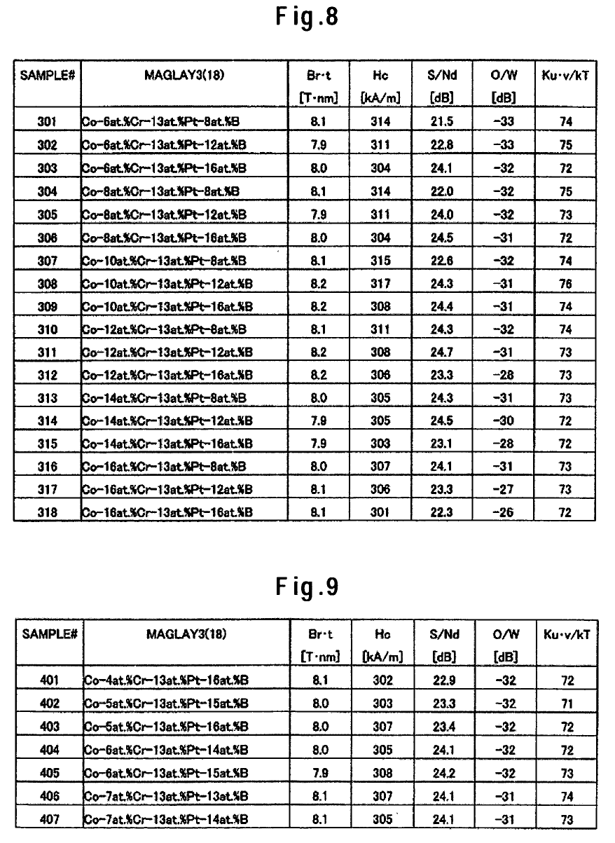

Magnetic recording media were formed by controlling the film thickness of the second and third magnetic layers so that Br3·t3=Br2·t2−Br1−t1 at about Br·t=8T·nm. FIG. 8 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

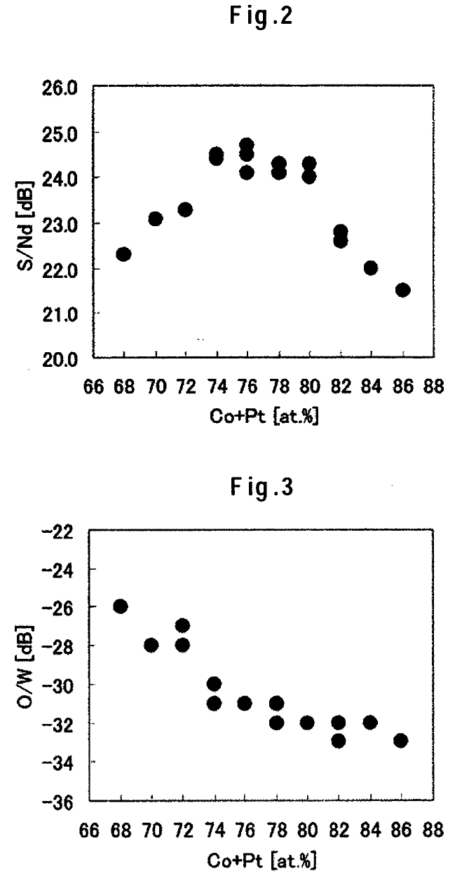

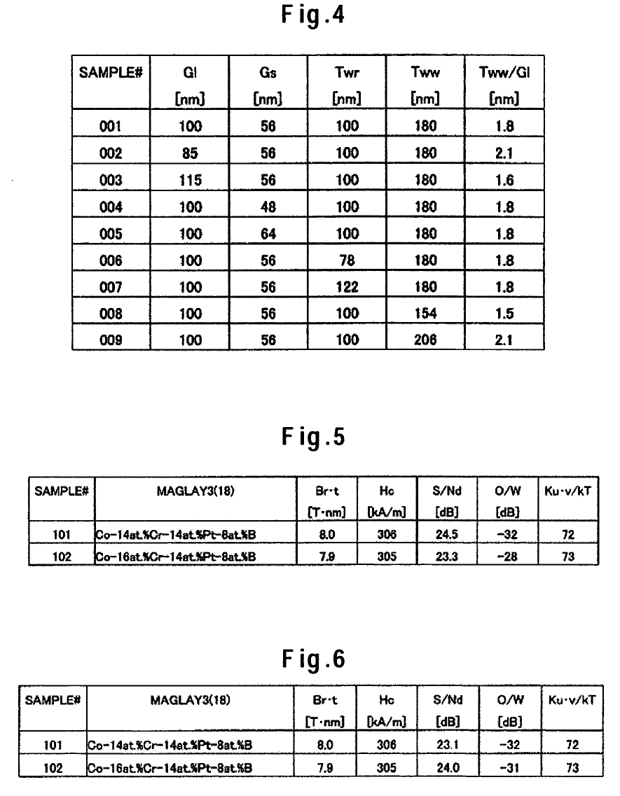

In view of FIG. 8, good S/Nd which was 24 dB or more and the good absolute value of O/W which was 30 dB or more were obtained on media whose total content of Co and Pt in the third magnetic layer was from 74 to 80 at. %, such that the specimen Nos. (SAMPLE #) were 303, 305, 306, 308 to 311, 313, 314 and 316. On the contrary, while the absolute value of O/W was 30 dB or more, S/Nd was deteriorated by 1 dB or more to 23 dB or less for all the media whose total content of Co and Pt in the third magnetic layer was 80 at. % or more, such that the specimen Nos. (SAMPLE #) were 301, 302, 304 and 307. Further, the absolute value of O/W was decreased by 2 dB or more to 28 dB or less and S/Nd was deteriorated by 0.5 dB or more to 23.5 dB or less for all the media whose total content of Co and Pt in the third magnetic layer was less than 74 at. %, such that specimen Nos. (SAMPLE #) were 312, 315, 317, and 318. FIGS. 2 and 3 show the dependence of S/Nd and O/W on the total content of Co and Pt in the third magnetic layer. In view of FIGS. 2 and 3, it has been found that good S/Nd and good O/W can be compatibilized when the total content of Co and Pt in the third magnetic layer was 74 at. % or more and 80 at. % or less. This can be explained as below. When the total content of Co and Pt in the third magnetic layer decreases excessively, since the magnetization of the magnetic layer decreases and the film thickness increases, the overwrite characteristic is deteriorated. On the contrary, when the total content of Co and Pt in the third magnetic layer is excessively large, since the concentration of Cr and B is lowered, the medium noise increases. Therefore, to make the good overwrite characteristic and noise reduction compatible, it is effective to control the total content of Co and Pt in the third magnetic layer within an appropriate range.

As has been described above, when the total content of Co and Pt in the third magnetic layer is about 74 at. % or more and about 80 at. % or less, a magnetic recording medium having an adequate S/Nd to attain an areal recording density of 150 or more Mbit per mm², an excellent O/W characteristic and sufficient stability against thermal fluctuation can be obtained.

### EXAMPLE 3

The concentration of chromium (Cr) in the third magnetic layer (18) was studied in view of S/Nd, an overwrite characteristic and thermal stability. Magnetic recording media were formed in the same manner as described in Example 1 except for changing the composition of the third magnetic layer. The following seven alloy targets were used for the third magnetic layer.
Co-4 at. % Cr-13 at. % Pt-16 at. % B,
Co-5 at. % Cr-13 at. % Pt-15 at. % B,
Co-5 at. % Cr-13 at. % Pt-16 at. % B,
Co-6 at. % Cr-13 at. % Pt-14 at. % B,
Co-6 at. % Cr-13 at. % Pt-15 at. % B,
Co-7 at. % Cr-13 at. % Pt-13 at. % B,
Co-7 at. % Cr-13 at. % Pt-14 at. % B.

Magnetic recording media were formed by controlling the film thicknesses of the second and third magnetic layers so that Br3·t3=Br2·t2−Br1·t1 at about Br·t=8 T·nm. FIG. 9 shows the results of the evaluation of S/Nd, O/W by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the result of the evaluation of Ku·v/kT.

Ku·v/kT of 71 or more and the good absolute value of O/W which was 30 dB or more were obtained on all the specimens in FIG. 9. Good S/Nd which was 24 dB or more was obtained on the media whose concentration of Cr in the third magnetic layer was 6 at. % or more (specimen Nos. (SAMPLE #) 404-407). However, S/Nd was deteriorated by 0.5 dB or more for the specimens whose Cr concentration was 5 at. % or less (specimen Nos. (SAMPLE #) 401-403). From the results described above, it is preferred that the Cr concentration in the third magnetic layer is about 6 at. % or higher for reducing the noise.

As has been described above, a magnetic recording medium having an adequate S/Nd to attain an areal recording density of 150 or more Mbit per mm², an excellent O/W characteristic and sufficient stability against thermal fluctuation can be obtained.

### EXAMPLE 4

The concentration of Boron (B) in the third magnetic layer (18) was studied in view of S/Nd, an overwrite characteristic and thermal stability. Magnetic recording media were formed in the same manner as described in Example 1 except for changing the composition of the third magnetic layer. The following seven alloy targets were used for the third magnetic layer.
Co-16 at. % Cr-13 at. % Pt-5 at. % B,
Co-15 at. % Cr-13 at. % Pt-5 at. % B,
Co-15 at. % Cr-13 at. % Pt-6 at. % B,
Co-14 at. % Cr-13 at. % Pt-6 at. % B,
Co-14 at. % Cr-13 at. % Pt-7 at. % B,
Co-13 at. % Cr-13 at. % Pt-7 at. % B,
Co-13 at. % Cr-13 at. % Pt-8 at. % B.

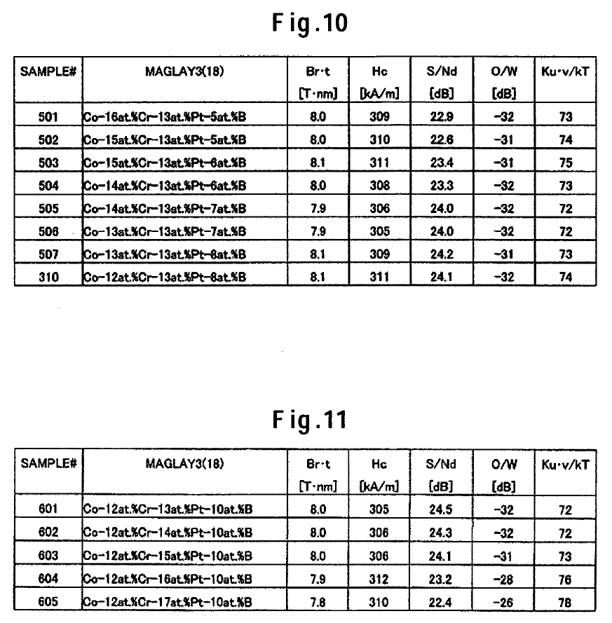

The magnetic recording media were formed by controlling the film thicknesses of the second and third magnetic layers so that Br3·t3=Br2·t2−Br1·t1 at about Br·t=8 T·nm. FIG. 10 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

FIG. 10 also shows the specimen No. (SAMPLE #) 310 of Example 3 using Co-12 at. % Cr-13 at. % Pt-8 at. % B for the third magnetic layer. Ku·v/kT of 71 or more and the good absolute value of O/W characteristic which was 30 dB or more were obtained on all the specimens in FIG. 10. Good S/Nd which was 24 dB or more was obtained on the media whose concentration of B in the third magnetic layer was about 7 at. % or more (specimen Nos. (SAMPLE #) 505-507, 210). However, S/Nd was deteriorated by 0.5 dB or more for the media whose B concentration was about 6 at. % or lower (specimen Nos. (SAMPLE #) 501-504).

It is difficult to add B with high concentration in excess of about 16 at. % to the third magnetic layer due to the problem with the workability of the target. When an alloy containing B at a concentration exceeding about 16 at. % is to be fabricated into a target after vacuum melting, it is difficult to be fabricated as the target because the target tends to be cracked.

From the results described above, B added to the third magnetic layer is preferably about 7 at. % or more for reducing the medium noise. Further, it is preferably about 16 at. % or less in view of the target fabrication. As has been described above, a magnetic recording medium having an adequate S/Nd to attain an areal recording density of 150 or more Mbit per mm², an excellent O/W characteristic and sufficient stability against thermal fluctuation can be obtained.

### EXAMPLE 5

The concentration of platinum (Pt) in the third magnetic layer (18) was studied from the view point of S/Nd, an overwrite characteristic and thermal stability. In the study, R/W performance of media whose Pt concentration of the third magnetic layer (MAGLAY3) was changed was measured. Magnetic recording media were formed in the same manner as described in Example 1 except for changing the composition of the third magnetic layer. The following five alloy targets were used for the third magnetic layer.
Co-12 at. % Cr-13 at. % Pt-10 at. % B,
Co-12 at. % Cr-14 at. % Pt-10 at. % B,
Co-12 at. % Cr-15 at. % Pt-10 at. % B,
Co-12 at. % Cr-16 at. % Pt-10 at. % B,
Co-12 at. % Cr-17 at. % Pt-10 at. % B.

Magnetic recording media were formed by controlling the film thicknesses of the second and third magnetic layers so that Br3·t3=Br2·t2−Br1·t1 at about Br·t=8 T·nm. FIG. 11 shows the results of the evaluation of S/Nd and O/W of the media by using a head whose writing gap length was 100 nm, gap length between the shields was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

Ku·v/kT of 71 or more was obtained in all the media in FIG. 11. Good S/Nd which was 24 dB or more and the good absolute value of O/W which was 30 dB or more were obtained on the media whose Pt concentration was about 15 at. % or less (specimen Nos. (SAMPLE #) 601 to 603). However, S/Nd was deteriorated by 0.5 dB or more and the absolute value of O/W was deteriorated by 3 dB or more for the media whose Pt concentration of about 16 at. % or more (specimen Nos. (SAMPLE #) 604 and 605).

Accordingly, it is preferred that the concentration of Pt contained in the third magnetic layer is about 15 at. % or less. This is because the overwrite characteristic tends to be deteriorated by the increase of the anisotropic magnetic field in the magnetic film as the Pt concentration is higher than that described above.

As has been described above, when the concentration of Pt in the third magnetic layer is about 15 at. % or less, a magnetic recording medium having an adequate S/Nd to attain an areal recording density of 150 or more Mbit per mm², an excellent O/W characteristic and sufficient stability against thermal fluctuation can be obtained.

### EXAMPLE 6

The effect of adding tantalum (Ta) to the third magnetic layer (18) was studied from the view point of S/Nd, an overwrite characteristic and thermal stability. In the study, R/W performance of media whose Ta concentration in the third magnetic layer (MAGLAY3) was changed was measured. Magnetic recording media were formed in the same manner as described in Example 1 except for changing the composition of the third magnetic layer. The following six alloy targets were used for the third magnetic layer.
Co-12 at. % Cr-14 at. % Pt-8 at. % B-1 at. % Ta,
Co-12 at. % Cr-14 at. % Pt-8 at. % B-2 at. % Ta,
Co-12 at. % Cr-14 at. % Pt-8 at. % B-3 at. % Ta,
Co-12 at. % Cr-14 at. % Pt-8 at. % B-4 at. % Ta,
Co-12 at. % Cr-14 at. % Pt-8 at. % B-5 at. % Ta,
Co-12 at. % Cr-14 at. % Pt-8 at. % B-6 at. % Ta.

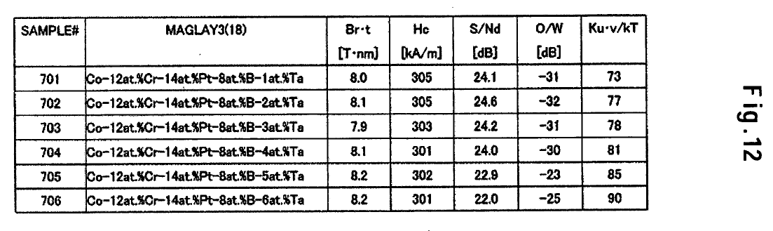

Magnetic recording media were formed by controlling the film thicknesses of the second and third magnetic layers so that Br3·t3=Br2·t2−Br1·t1 at about Br·t=8 T·nm. FIG. 12 shows the results of the evaluation of S/Nd and O/W of the media by using a head whose writing gap length of 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

As shown in FIG. 12, Ku·v/kT of 71 or more was obtained and the value of Ku·v/kT increased as the Ta concentration of the third magnetic layer increased in all media. Good S/Nd which was 24 dB or more and the good absolute value of O/W which was 30 dB or more were obtained on the media whose Ta concentration was about 4 at. % or less (specimen Nos. (SAMPLE #) 701 to 704). However, S/Nd was deteriorated by 1 dB or more and O/W was deteriorated by 3 dB or more for the media whose Ta concentration was about 5 at. % or more (specimen Nos. (SAMPLE #) 705 to 706).

As the results of the study described above, to ensure the overwrite characteristic, the concentration of Ta added to the third magnetic layer is preferably about 4 at. % or lower. Further, the concentration of Ta added to the third magnetic layer is preferably about 1 at. % or higher since the thermal stability is improved. This can be explained as below. When Ta is added to the Co-based alloy containing Pt, Cr and B, the melting point is lowered. This leads to the effect of decreasing the stacking faults during film growth in the sputtering and result in the improvement of the thermal stability. However, since magnetization of the magnetic layer decreases when the concentration of Ta added to the third magnetic layer is excessive, the film thickness increases for ensuring a constant Br·t and the overwrite characteristic is deteriorated.

As described above, a magnetic recording medium having an adequate S/Nd to attain an areal recording density of 150 or more Mbit per 1 m², an excellent O/W characteristic and higher thermal stability can be obtained. Further, application of a bias voltage from −100 to −400 V to the substrate during the film formation of the third magnetic layer is preferred in this example since Ku·v/kT increases more.

### EXAMPLE 7

The effect of adding copper (Cu) to the third magnetic layer (18) was studied from the view point of S/Nd, an overwrite characteristic and thermal stability. In the study, the R/W performance of media whose Cu concentration in the third magnetic layer (MAGLAY3) was changed was measured. Magnetic recording media were formed in the same manner as described in Example 1 except for changing the composition of the third magnetic layer. The following six alloy targets were used for the third magnetic layer.
Co-12 at. % Cr-12 at. % Pt-8 at. % B-1 at. % Cu,
Co-12 at. % Cr-12 at. % Pt-8 at. % B-2 at. % Cu,
Co-12 at. % Cr-12 at. % Pt-8 at. % B-3 at. % Cu,
Co-12 at. % Cr-12 at. % Pt-8 at. % B-4 at. % Cu,
Co-12 at. % Cr-12 at. % Pt-8 at. % B-5 at. % Cu,
Co-12 at. % Cr-12 at. % Pt-8 at. % B-6 at. % Cu.

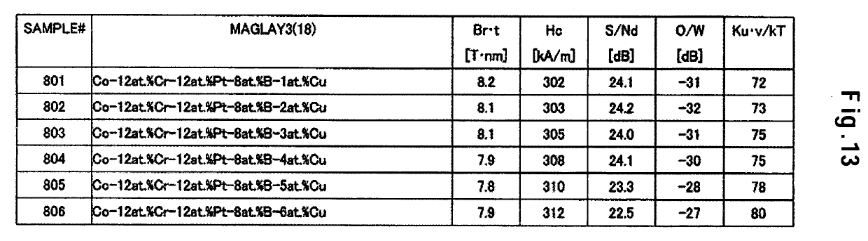

Magnetic recording media were formed by controlling the film thicknesses of the second and third magnetic layers so that Br3·t3=Br2·t2−Br1 t1 at about Br·t=8 T·nm. FIG. 13 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

In all of media in the example shown in FIG. 13, Ku·v/kT of 71 or more was obtained and the value of Ku·v/kT increased as the Cu concentration of the third magnetic layer increased. Good S/Nd which was 24 dB or more and the good absolute value of O/W which was 30 dB or more were obtained on the media whose Cu concentration was about 4 at. % or less (specimen Nos. (SAMPLE #) 801 to 804). However, S/Nd was deteriorated by 0.5 dB or more and O/W was deteriorated by 2 dB or more for the media whose Cu concentration was about 5 at. % or more (specimen Nos. (SAMPLE #) 805 and 806).

As a result of the study described above, to ensure the overwrite characteristic, the concentration of Cu added to the third magnetic layer is preferably about 4 at. % or less. Further, the concentration of Cu added to the third magnetic layer is preferably about 1 at. % or more since the thermal stability is improved. This can be explained as below. When Cu is added to the Co-based alloy containing Pt, Cr and B, since the segregation of Cr during film formation is promoted and the anisotropic energy of the magnetic film is increased, the thermal stability is improved. However, when the concentration of Cu added to the third magnetic layer is excessive, since magnetization of the magnetic layer decreases, the film thickness increases for keeping Br·t constant, and the overwrite characteristic is deteriorated.

As described above, a magnetic recording medium having an adequate S/Nd to attain an areal recording density of 150 or more Mbit per 1 m², an excellent O/W characteristic and higher thermal stability could be attained. Further, application of a bias voltage from −100 to −400 V to the substrate during film formation of third magnetic layer is preferred in this example since Ku·v/kT increases more.

### EXAMPLE 8

The effect of adding tantalum (Ta) and copper (Cu) to the third magnetic layer (18) was studied from the view point of S/Nd, an overwrite characteristic and thermal stability. In the study, the R/W performance of media whose Cu concentration in the third magnetic layer (MAGLAY3) was changed was measured. Magnetic recording media were formed in the same manner as described in Example 1 except for changing the composition of the third magnetic layer. The following four alloy targets were used for the third magnetic layer.
Co-12at. % Cr-13 at. % Pt-8 at. % B-0.5 at. % Ta-0.5 at. % Cu,
Co-12 at. % Cr-13 at. % Pt-8 at. % B-1 at. % Ta-1 at. % Cu,
Co-12 at. % Cr-13 at. % Pt-8 at. % B-at. % Ta-2 at. % Cu,
Co-12 at. % Cr-13 at. % Pt-8 at. % B-3 at. % Ta-3 at. % Cu.

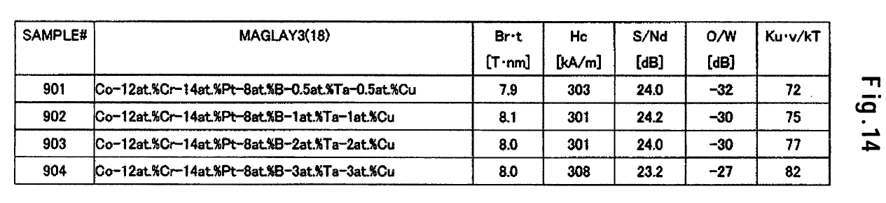

Magnetic recording media were formed by controlling the film thicknesses of the second and third magnetic layers so that Br3·t3=Br2·t2−Br1·t1 at about Br·t=8 T·nm. FIG. 14 shows the results of the evaluation of S/Nd, O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

As shown in FIG. 14, Ku·v/kT of 71 or more was obtained and the value of Ku·v/kT gradually increased along with increase of the concentration of Ta and Cu for all media. Good S/Nd which was 24 dB or more and the good absolute value of OJW which was 30 dB or more were obtained on the media whose total concentration of Ta and Cu in the third magnetic layer was about 4 at. % or less (specimen Nos. (SAMPLE #) were 901 to 904). However, S/Nd was deteriorated by 0.5 dB or more and O/W was deteriorated by 3 dB or more for the media whose total concentration of Ta and cu was about 6 at. % or more (specimen No. (SAMPLE #) 905.

As a result of the study described above, to ensure the overwrite characteristic, it is preferred that the total content of Ta and Cu added to the third magnetic layer is about 4 at. % or less. Further, it is preferred that the total content of Ta and Cu added to the third magnetic layer is about 1 at. % or more since the thermal stability is improved. Thus, a magnetic recording medium having an adequate S/Nd to attain an areal recording density of 150 or more Mbit per mm², an excellent O/W characteristic and higher thermal stability can be obtained.

Further, application of a bias voltage from −100 to −400 V to the substrate during film formation of the third magnetic layer is preferred in this embodiment since Ku·v/kT is further increased.

### EXAMPLE 9

The concentration of platinum (Pt) in the second and third magnetic layers (16, 18) was studied from the view point of S/Nd, an overwrite characteristic and thermal stability. Magnetic recording media were formed in the same manner as described in Example 1 except for changing the composition of the second magnetic layer. The following four alloy targets were used for the second magnetic layer.
Co-20 at. % Cr-13 at. % Pt-6 at. % B,
Co-20 at. % Cr-14 at. % Pt-6 at. % B,
Co-20 at. % Cr-15 at. % Pt-6 at. % B,
Co-20 at. % Cr-16 at. % Pt-6 at. % B.

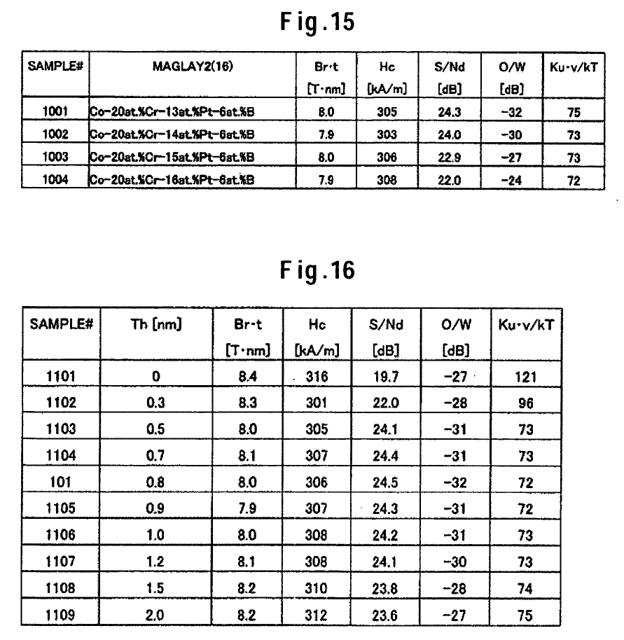

Magnetic recording media were formed by controlling the film thicknesses of the second and the third magnetic layers so that Br3·t3=Br2·t2−Br1·t1 at about Br·t=8 T·nm. FIG. 15 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

Ku·v/kT of 71 or more was obtained on all media of this example in FIG. 15. Good S/Nd which was 24 dB or more and the good absolute value of O/W which was 30 dB or more were obtained on the media whose Pt concentration in the second magnetic layer (MAGLAY2) (16)) was about 14 at. % or less and less than the concentration of Pt in the third magnetic layer (specimen Nos. (SAMPLE #) 1001, and 1002). On the other hand, S/Nd was deteriorated by 1 dB or more and O/W was deteriorated by 3 dB or more for the media whose concentration of Pt in the second magnetic layer was greater than that in the third magnetic layer (specimen Nos. (SAMPLE #) 1003, 1004). This can be explained as below. When the Pt concentration of the second magnetic layer is greater than that in the third magnetic layer, the anisotropy field in the second magnetic field in which the writing field is relatively small is larger than the anisotropy field in the third magnetic layer which is close to the head, and the O/W is deteriorated.

As described above, when the concentration of Pt contained in the second magnetic layer is less than that in the third magnetic layer, the overwrite characteristic and S/Nd are improved. In particular, it is not preferred the concentration of Pt contained in the second magnetic layer is greater than that in the third magnetic layer since the overwrite characteristic is deteriorated. Thus, a magnetic recording medium having an adequate S/Nd to attain an areal recording density of 150 or more Mbit per mm², an excellent O/W characteristic and sufficient stability against thermal fluctuation can be obtained.

### EXAMPLE 10

A suitable thickness for the second intermediate layer (17) that attains anti-ferromagnetical coupling between the second and third magnetic layers (16, 18) was studied from the view point of S/Nd, an overwrite characteristic and thermal stability. In the study, magnetic recording media were formed in the same manner as described in Example 1 except for setting the film thickness of the second intermediate layer on 0 nm, 0.3 nm, 0.5 nm, 0.7 nm, 0.9 nm, 1.0 nm, 1.2 nm, 1.5 nm and 2.0 nm. FIG. 16 shows the results of the evaluation of S/Nd and O/W of the media by using a head whose writing gap length was 100 nm, inter-shield gap length was 56 nm, geometrical reading track width was 100 nm, and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT.

FIG. 16 also shows the results of the medium of specimen No. (SAMPLE #) 101 in Example 1 whose thickness (Th) of the second intermediate layer (17) was 0.8 nm. Ku·v/kT of 71 or more was obtained on all the media of the example in FIG. 15. Good S/Nd which was 24 dB or more and the good absolute value of O/W which was 30 dB or more were obtained on the media whose thickness of the second intermediate layer was from 0.5 to 1.2 nm (specimen Nos. (SAMPLE #) 1103, 1104, 101, 1105 to 1107). However, S/Nd was deteriorated by 2 dB or more and O/W was deteriorated by 2 dB or more for the media whose film thickness (Th) of the second intermediate layer was 0 nm and 0.3 nm (specimen Nos. (SAMPLE #) 1101, 1102). Further, for the media whose thickness of the second intermediate layer was 1.5 nm and 2.0 nm (specimen Nos. (SAMPLE #) 1108, 1109), while degradation of S/Nd was small, O/W was deteriorated by 2 dB or more.

From the results of the study described above, a magnetic recording medium having an adequate S/Nd to attain an areal recording density of 150 or more Mbit per mm², an excellent O/W characteristic and sufficient stability against thermal fluctuation can be attained by setting the film thickness (Th) of the second intermediate layer within a range from about 0.5 to 1.2 nm.

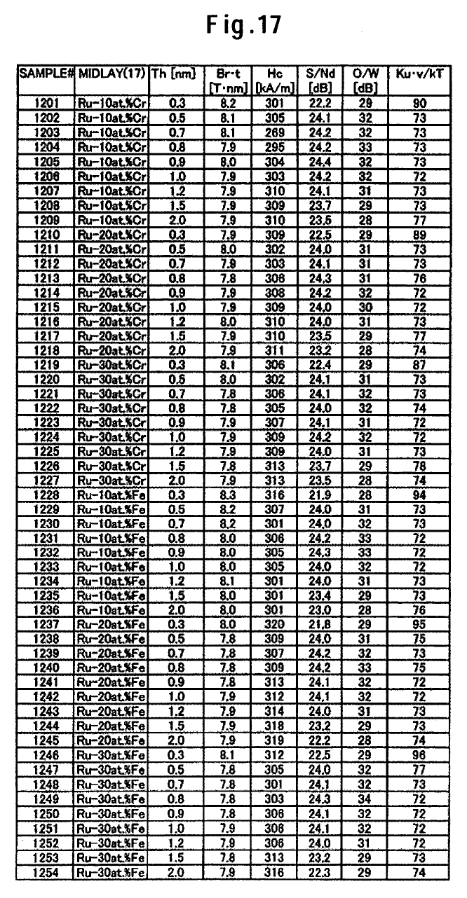

The dependence on the film thickness of the second intermediate layer (17) attaining the anti-ferromagnetical coupling between the second and third magnetic layers (16, 18) was studied from the view point of S/Nd, an overwrite characteristic and thermal fluctuation. Instead of the 0.8 nm-thick second intermediate layer comprising Ru in Example 1, Ru-10 at. % Cr, Ru-20 at. % Cr, Ru-30 at. % Cr, Ru-10 at. % Fe, Ru-20 at. % Fe, and Ru-30 at. % Fe were each formed on a thickness of 0.3 nm, 0.5 nm, 0.7 nm, 0.8 nm, 0.9 nm, 1.0 nm, 1.2 nm, 1.5 nm and 2.0 nm. Magnetic recording media were formed in the same manner as described in Example 1 except for the foregoing. S/Nd, O/W, and Ku·v/kT of the media were evaluated. FIG. 17 shows the results of the evaluation of S/Nd and O/W of the media by using a head whose writing gap length was 100 nm, inter-shield gap length was 56 nm, geometrical reading track width was 100 nm and geometrical writing track width was 180 nm, at a low recording density 1F signal which was 5.31 kFC/mm (135 kFCI) and at a high recording density 2F signal which was 31.9 kFC/mm (810 kFCI), and shows the results of the evaluation of Ku·v/kT. Good S/Nd which was 24 dB or more, the good absolute value of O/W which was 30 dB or more and good Ku·v/kT which was 71 or more were obtained in all media whose film thickness (Th) of the second intermediate layer (MIDLAY(17)) was from about 0.5 nm to 1.2 nm (specimen Nos. (SAMPLE #) 1202 to 1208, 1211 to 1216, 1220 to 1225, 1229 to 1234, 1238 to 1243, 1247 to 1252). As described above, it is demonstrated that the characteristics are not degraded even if Cr or Fe is contained, when the thickness of the second intermediate layer is within a range of from about 0.5 nm to 1.2 nm.

It is preferred that the second intermediate layer (17) formed between the second magnetic layer and the third magnetic layer is an alloy comprising Ru as the main ingredient and has a thickness of from about 0.5 to 1.2 nm. Also in a case of forming the second intermediate layer by sputtering a target containing Ru, the layer may sometimes contain the constituent elements in the upper and lower layers. When the thickness of the second intermediate layer is about 0.5 nm or less, medium noise attributable to the increase of the exchange coupling increases, and S/Nd decreases extremely. S/Nd is improved most when the thickness of the second intermediate layer is set on from about 0.5 nm to 1.2 nm. When the thickness of the second intermediate layer is more than about 1.2 nm, the S/Nd and the overwrite characteristic are gradually lowered. Accordingly, it is preferred that the second intermediate layer comprises Ru as the main ingredient and has a thickness within a range from about 0.5 to 1.2 nm. As described above, a magnetic recording medium having an adequate S/Nd to attain an areal recording density of 150 or more Mbit per mm², an excellent O/W characteristic and sufficient stability against thermal fluctuation.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A magnetic recording medium comprising:
an underlayer, a first magnetic layer, a first intermediate layer, a second magnetic layer, a second intermediate layer, a third magnetic layer, a protective layer, and a lubricant layer, which are deposited in sequence on a substrate;
wherein:
the first magnetic layer comprises a cobalt-based alloy;
each of the second magnetic layer and the third magnetic layer comprises a cobalt-based alloy containing platinum, chromium and boron;
a concentration of chromium contained in the third magnetic layer is less than a concentration of chromium contained in the second magnetic layer;
the concentration of chromium contained in the third magnetic layer is about 15 at. % or less; and
the first intermediate layer comprises ruthenium or an alloy mainly comprising ruthenium.

2. A magnetic recording medium according to claim 1, wherein the concentration of chromium contained in the third magnetic layer is about 6 at. % or more.

3. A magnetic recording medium according to claim 1, wherein a concentration of platinum contained in the third magnetic layer is equal to or more than a concentration of platinum contained in the second magnetic layer and is about 15 at. % or less.

4. A magnetic recording medium according to claim 1, wherein a total content of cobalt and platinum contained in the third magnetic layer is about 74 at. % or more and about 80 at. % or less.

5. A magnetic recording medium according to claim 1, wherein a concentration of boron contained in the third magnetic layer of the magnetic recording medium is about 7 at. % or more.

6. A magnetic recording medium according to claim 1, wherein the cobalt-based alloy in the third magnetic layer further contains tantalum, and a concentration of tantalum contained in the third magnetic layer is about 4 at. % or less.

7. A magnetic recording medium according to claim 1, wherein the cobalt-based alloy in the third magnetic layer further contains copper; and,
a concentration of copper contained in the third magnetic layer is about 4 at. % or less.

8. A magnetic recording medium according to claim 1, wherein the cobalt-based alloy in the third magnetic layer further contains tantalum and copper, and
a total content of tantalum and copper contained in the third magnetic layer is about 4 at. % or less.

9. A magnetic recording medium according to claim 1, wherein the second intermediate layer has a thickness of about 0.5 nm or more and about 1.2 nm or less.

10. A magnetic recording medium according to claim 1, wherein the underlayer is formed by stacking a titanium alloy layer containing at least one element selected from cobalt and nickel, a tungsten alloy layer containing cobalt, and a chromium alloy layer containing titanium and boron in sequence on the substrate.

11. A magnetic recording medium according to claim 1, wherein the substrate has a texture in which a plurality of circumferential grooves are formed in a radial direction.

12. A magnetic recording apparatus comprising:
a magnetic recording medium;
a driving section configured to drive the magnetic recording medium for rotation; and
a compound head having writing and reading heads,
wherein:
the magnetic recording medium comprises a substrate, an underlayer, a first magnetic layer, a second magnetic layer, a third magnetic layer, a first intermediate layer disposed between the first and second magnetic layers, a second intermediate layer disposed between the second and third magnetic layers, a protective layer, and a lubricant layer,
the first magnetic layer is disposed between the underlayer and the second magnetic layer,
the third magnetic layer is disposed between the second intermediate layer and the protective layer,
the first magnetic layer comprises a cobalt-based alloy,
each of the second magnetic layer and the third magnetic layer comprises a cobalt-based alloy containing platinum, chromium and boron,
a concentration of chromium contained in the third magnetic layer is less than a concentration of chromium contained in the second magnetic layer,
the concentration of chromium contained in the third magnetic layer is about 15 at. % or less,
the first intermediate layer comprises ruthenium or an alloy mainly comprising ruthenium, and
a ratio of a writing gap length of the writing magnetic head to a geometrical writing track width is from about 1.5 to 2.1.

13. A magnetic recording apparatus according to claim 12, wherein the writing gap length is about 115 nm or less and the geometrical writing track width is about 206 nm or less.

14. A magnetic recording apparatus according to claim 12, wherein a gap length between shields of the reading head is about 64 nm or less and the geometrical reading track width is about 122 nm or less.

15. A magnetic recording apparatus according to claim 12, wherein the concentration of chromium contained in the third magnetic layer is about 6 at. % or more.

16. A magnetic recording apparatus according to claim 12, wherein a concentration of platinum contained in the third magnetic layer is equal to or more than a concentration of platinum contained in the second magnetic layer and about 15 at. % or less.

17. A magnetic recording apparatus according to claim 12, wherein a total content of cobalt and platinum contained in the third magnetic layer is about 74 at. % or more and about 80 at. % or less.

18. A magnetic recording apparatus according to claim 12, wherein a concentration of boron contained in the third magnetic layer of the magnetic recording medium is about 7 at. % or more.

19. A magnetic recording apparatus according to claim 12, wherein the cobalt-based alloy in the third magnetic layer further contains tantalum, and a concentration of tantalum contained in the third magnetic layer is about 4 at. % or less.

20. A magnetic recording apparatus according to claim 12, wherein the cobalt-based alloy in the third magnetic layer further contains copper, and a concentration of copper contained in the third magnetic layer is about 4 at. % or less.

21. A magnetic recording apparatus according to claim 12, wherein the cobalt-based alloy in the third magnetic layer further contains tantalum and copper, and a total content of tantalum and copper contained in the third magnetic layer is about 4 at. % or less.

22. A magnetic recording apparatus according to claim 12, wherein a thickness of the second intermediate layer is about 0.5 nm or more and about 1.2 nm or less.

23. A magnetic recording apparatus according to claim 12, wherein the underlayer is formed by stacking a titanium alloy layer containing at least one element selected from cobalt and nickel, a tungsten alloy layer containing cobalt, and a chromium alloy layer containing titanium and boron in sequence on the substrate.

24. A magnetic recording apparatus according to claim 12, wherein the substrate has a texture in which a plurality of circumferential grooves are formed in a radial direction.
